(19) United States
(12) Patent Application Publication
(10) Pub. No.: US 2016/0248081 A1
(43) Pub. Date: Aug. 25, 2016

(54) ELECTRODE FOR ELECTRICAL ENERGY STORAGE BATTERIES COMPRISING A GRAPHITE/SILICON/CARBON FIBER COMPOSITE MATERIAL

(71) Applicant: RENAULT S.A.S., Boulogne-billancourt (FR)

(72) Inventors: Marc BOHNKE, Le Gua (FR); Sophie CHAZELLE, Vourey (FR); Elise GUTEL, Veurez-Voroize (FR); Coralie LORFEUVRE, Brison Saint Innocent (FR); Mohamed CHAKIR, Saint Germain Les Arpajon (FR)

(73) Assignee: RENAULT s.a.s., Boulogne-Billancourt (FR)

(21) Appl. No.: 15/025,781

(22) PCT Filed: Sep. 30, 2014
(86) PCT No.: PCT/FR2014/052456

§ 371 Date: Mar. 29, 2016

(30) Foreign Application Priority Data
Sep. 30, 2013 (FR) 1359429

(51) Int. Cl. H01M 4/36; H01M 4/587; H01M 4/38; H01M 4/131; H01M 2/16; H01M 4/525; H01M 4/62; H01M 10/0525; H01M 10/0569; H01M 10/0568; H01M 4/133; H01M 4/505

(52) U.S. Cl. CPC H01M 4/364; H01M 4/133; H01M 4/587; H01M 4/386; H01M 4/131; H01M 4/505; H01M 4/525; H01M 4/622; H01M 4/621; H01M 10/0525; H01M 10/0569; H01M 10/0568; H01M 2/1653; H01M 2004/027

(57) ABSTRACT

A composite electrode material is based on graphitic carbon and includes a ground product, dispersed within the graphitic carbon, of an intimate mixture of carbon fibers and silicon. The composite electrode material can be included in an electrode for electrical energy storage batteries along with one or more binders. The electrode is prepared by mechanically grinding carbon fibers and silicon particles in the presence of a solvent, drying the mixture until the solvent has disappeared completely, adding the dried ground product to the particles of graphitic carbon, mixing the whole in the presence of at least one binder, spreading the mixture on a current collector, and then drying.

The invention relates to a graphite-based electrode material comprising carbon fibers and silicon.

More precisely, the invention relates to a composite electrode material based on graphitic carbon comprising a ground product of an intimate mixture of carbon fibers and silicon, dispersed in graphitic carbon.

The invention also relates to an electrode for an electrical energy storage battery comprising such a material.

Finally, the invention relates to an electrical energy storage battery comprising such an electrode.

Li-ion batteries are being used increasingly as an autonomous energy source, especially in applications connected with electric mobility. This trend can notably be explained by mass and volume energy densities well above those of the conventional nickel-cadmium (Ni—Cd) and nickel-metal hydride (Ni-MH) batteries, as well as by lowering of the kilowatt-hour costs associated with this technology.

Materials based on carbon, especially graphite, have been developed successfully and are widely marketed as electrochemically active materials for the negative electrode of Li-ion batteries. These materials have particularly good performance owing to their structure that is favorable to insertion and deinsertion of lithium and their stability during the various charge and discharge cycles. However, the theoretical specific capacity of graphite (372 mAh/g) is still well below that of metallic lithium (4000 mAh/g).

Certain metals capable of incorporating lithium have proved to be promising alternatives to the reference negative electrode materials based on crystalline carbon. In particular, with a theoretical capacity estimated at 3578 mAh/g, silicon represents an interesting alternative to graphite.

Nevertheless, at present, viable exploitation of silicon-based electrodes is not conceivable, since Li-ion batteries containing such electrodes have problems of loss of capacity during repeated charge/discharge cycles, regardless of the current regime envisaged. This problem is intrinsic to the presence of silicon. In fact, during charging, reduction of the lithium ions by electrochemical reaction leads to formation of an alloy LiₓSi.

As described by Koller et al., “High capacity graphite-silicon composite anode material for lithium-ion batteries”, Journal of Power Sources, 196, (2011), 2889-2892, formation of the alloy Li_{4.5}Si is accompanied by an increase in electrode volume that may reach 300%. Then, during discharge, delithiation of the alloy leads to the opposite phenomenon, namely decrease in particle volume.

This phenomenon and repetition of these cycles of expansion/contraction of the silicon particle will give rise to mechanical stresses within the latter, leading to its decrepitation and amorphization as described in the work by Lecras et al., Solid State Ionic, 36-44, 2012. The silicon particles will fracture as the cycles proceed.

Thus, each charge/discharge cycle will produce fresh active surface for reduction of the electrolyte, not leading to a stable solid-electrolyte interphase (SEI), an essential element for good operation of the battery, and thus creating an irreversible loss of capacity in each cycle.

Nanostructured silicon below a critical size estimated at about 150 nanometers has been proposed (Liu et al., ACS nano, 6, 1522-1531, 2012) for reducing the degradation of service life during the charge-discharge cycles, owing to its more limited fracturing.

The volume expansion of silicon, regardless of its size, or of the elements capable of forming an alloy with lithium, cannot be contained completely for the time being. Numerous studies of electrode formulation therefore have the objective of adapting to the latter. In this connection, work is for example very often conducted on the environment of the particle in order to limit the deformation of the electrode.

For example, mixtures of different compounds with silicon or else recourse to coatings of different natures are very often mentioned, for example in the following documents: FR2970245, U.S. Pat. No. 8,277,974, U.S. Pat. No. 7,906,236 and CN102931413.

However, this does not yet allow us to expect interesting performance in terms of loss of charge capacity as the charge-discharge cycles proceed.

Recourse to carbon fibers, to nanofibers or to carbon nanotubes, with silicon or with graphite-silicon, as well as the associated procedures, form one of the potential solutions explored in recent years (US20060035149, JP2005310760, US20080145757, WO201036648).

However, the use of carbon fibers is moreover not insignificant, owing to a very particular form factor of these particles. The latter pose certain problems of processability, notably through their agglomeration within the mixture in the aqueous process.

Moreover, they are relatively expensive compared to graphite and must therefore be used in a limited amount for these electrodes to be commercially viable.

It has now been discovered that a material based on graphite comprising a limited amount of silicon and of carbon fibers, these two elements first being mixed and ground intimately together and distributed homogeneously in the graphite base, could solve the problems of the prior art, namely increase the energy capacity of the electrode containing such a material while maintaining a considerable service life (and therefore cyclability).

The invention therefore relates to a composite electrode material based on graphitic carbon comprising a ground product of an intimate mixture of carbon fibers and silicon, dispersed within the graphitic carbon.

This material according to the invention is included in the composition of an electrode for electrical energy storage batteries.

Consequently, the invention also relates to an electrode for electrical energy storage batteries comprising the material as defined above.

The electrode according to the invention has a greater energy capacity than for an electrode consisting solely of graphite.

Moreover, the electrode according to the invention has good cyclability and therefore an improved service life.

The invention also relates to a lithium-ion storage battery for electrical energy comprising a negative electrode and a positive electrode, said negative electrode being according to the invention.

Finally, the invention relates to a method for preparing an electrode according to the invention comprising the following steps:
i) mechanically grinding carbon fibers and silicon particles in the presence of a solvent,
ii) drying the mixture obtained in step i) until the solvent has disappeared completely,
iii) adding the dried ground product obtained in step ii) to the particles of graphitic carbon,
iv) mixing the whole in the presence of at least one binder and optionally water,
v) spreading the mixture obtained in step iv) on a current collector,
vi) drying.

Other advantages and features of the invention will become clearer on examining the detailed description and the appended drawings, in which:

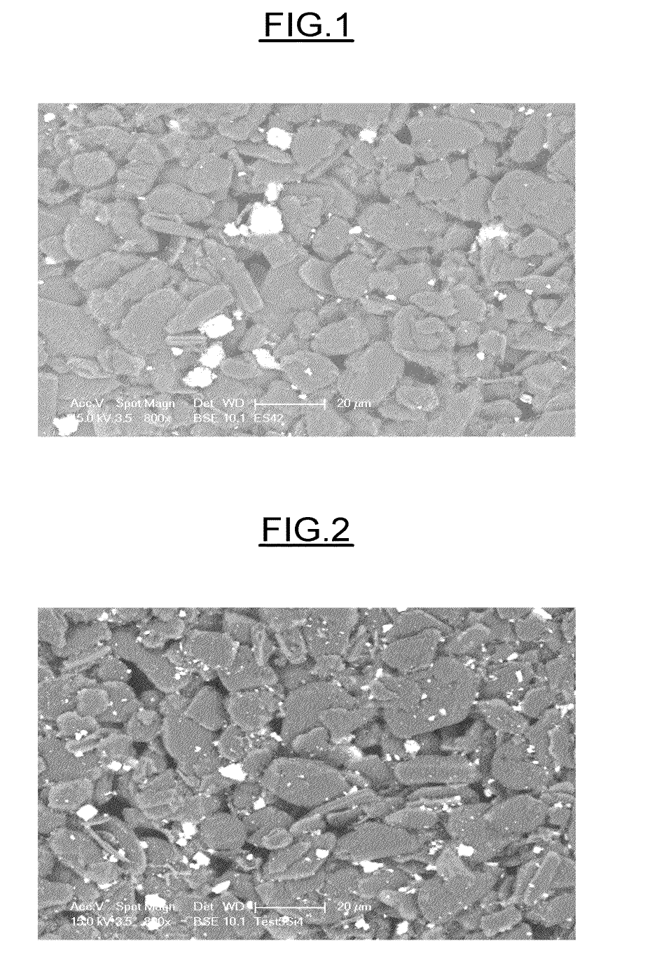

FIG. 1 shows a scanning electron micrograph of a comparative electrode,

FIG. 2 shows a scanning electron micrograph of an electrode according to the invention,

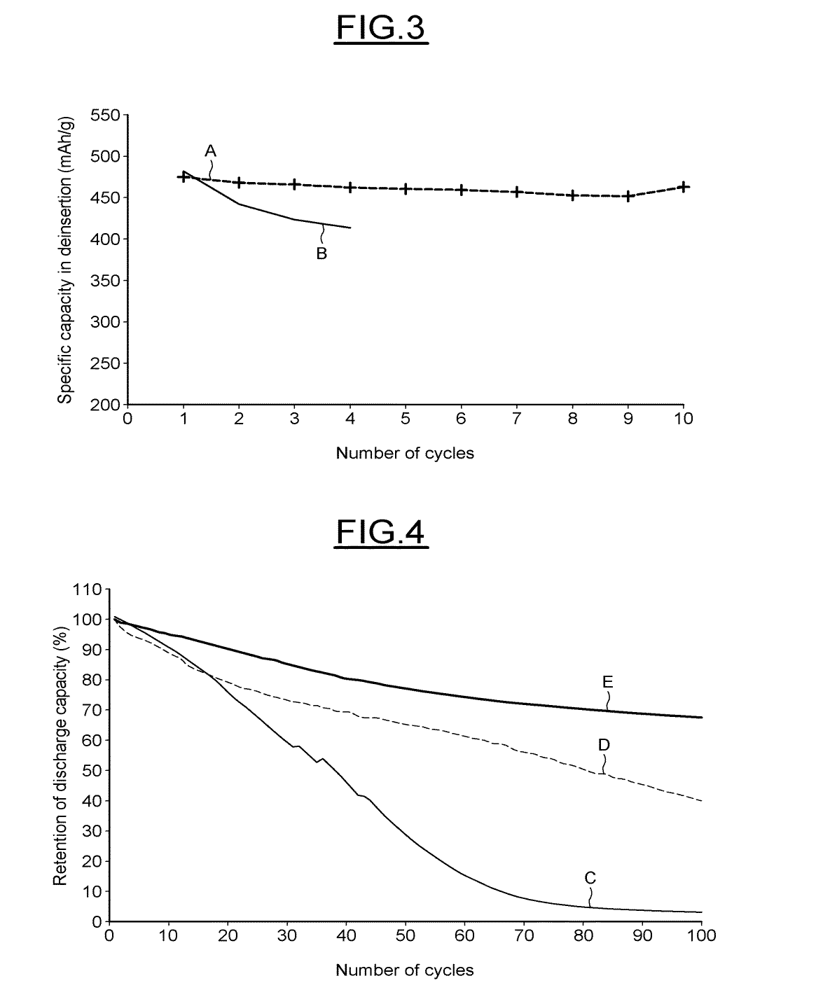

FIG. 3 compares the specific deinsertion capacities of an electrode according to the invention and of a comparative electrode as a function of the number of charge/discharge cycles,

FIG. 4 compares the retention of the discharge capacity of an electrode according to the invention and of two comparative electrodes as a function of the number of charge/discharge cycle, in a complete Li-ion cell.

In the description of the invention, the term “based on” is synonymous with “comprising predominantly”.

“Dispersion” means, in the sense of the present invention, that the ground product is distributed homogeneously in the graphite base.

“Homogeneous” means, in the sense of the present invention, and conventionally for a person skilled in the art, that the concentration of ground product in a given volume of the material is identical to the concentration of ground product in the total volume of the material.

“Intimate mixture” means that there is no segregation between the silicon and the carbon fibers, i.e. the two materials are mixed homogeneously.

“Room temperature” means preferably a temperature between 20° C. and 30° C., and preferably of about 25° C.

In the following, and unless stated otherwise, the limits of a range of values are included in this range, notably in the expression “between”.

The composite material according to the invention is based on graphitic carbon.

Thus, graphitic carbon is the predominant constituent of the composite material according to the invention; it constitutes the matrix of the composite material.

The graphitic carbon may be selected from the synthetic graphitic carbons, and natural starting from natural precursors followed by purification and/or a post-treatment.

Preferably, the graphitic carbon of the material according to the invention is selected from the synthetic graphitic carbons in the form of flakes.

Preferably, the graphitic carbon represents from 80 to 99 wt %, preferably from 85 to 97 wt %, and in particular from 89 to 95 wt %, relative to the total weight of the composite material.

The graphitic carbon is generally in the form of particles with average size between 1 and 100 μm, preferably between 5 and 80 μm, and in particular between 5 and 60 μm.

Preferably they are oblong particles or elongated spheres with a first average dimension between 5 and 10 microns and with the other average dimensions between 10 and 20 microns.

The particle size is generally measured by laser granulometry.

These particles of graphitic carbon generally have a specific surface area of between 6 and 8 m²/g.

As graphitic carbon usable according to the invention, we may notably mention TIMREX® SLP30 sold by the company TIMCAL.

The composite material according to the invention also comprises a ground product of an intimate mixture of carbon fibers and silicon.

The silicon used in the composite material according to the invention is originally in the form of spherical elementary particles or in the form of a secondary agglomerate of spherical elementary particles where the average size of the elementary particles is less than or equal to 4 μm, preferably less than or equal to 300 nm, and in particular less than or equal to 150 nm.

These particles or these agglomerates of particles generally have a BET (Brunauer, Emmett and Teller) specific surface area between 10 and 20 m²/g, preferably between 11 and 15 m²/g.

The size of the silicon particle is generally also measured by laser granulometry.

As silicon usable according to the invention, we may notably mention the silicon sold by the company Stile.

Preferably, silicon represents from 0.1 to 15 wt %, preferably from 1 to 10 wt %, and in particular from 3 to 8 wt %, relative to the total weight of the composite material.

The carbon fibers of the composite material according to the invention are preferably carbon fibers grown in the vapor phase (VGCF for “Vapor Grown Carbon Fibers”).

As carbon fibers, we may notably mention the carbon fibers of the VGCF type marketed by the company Showa Denko, or the TENAX fibers from the company Toho.

Preferably, the carbon fibers represent from 0.1 to 10 wt %, preferably from 0.5 to 5 wt %, and in particular from 1 to 3 wt %, relative to the total weight of the composite material.

The carbon fibers generally have an average length between 1 and 40 μm, preferably between 5 and 20 μm, and a diameter less than or equal to 150 nm.

The size of the carbon fibers is generally measured using a scanning electron microscope.

Quite especially preferably, in the electrode according to the invention, the weight ratio of the amount of silicon to the amount of carbon fibers is between 1 and 10, preferably between 1 and 5, and in particular between 2 and 3.

The ground product of silicon and of carbon fibers is generally obtained by mechanical grinding.

Preferably, the mechanical grinding is high-energy grinding.

It is preferably carried out in a planetary grinding mill with agate balls.

The planetary grinding mill used in the method according to the invention generally comprises 150 g to 180 g of agate balls.

Grinding is generally carried out at a rotary speed of 500 rev/min for 1.5 hours.

For example, it will be possible to use the grinding mill with the reference PM100 marketed by Retsch.

The invention also relates to an electrode for electrical energy storage batteries comprising the material as defined above, and one or more binders.

Preferably, the binder or binders may be selected from latices of polybutadiene-styrene, polybutadiene-nitrile and organic polymers, and preferably from latices of polybutadiene-styrene, polybutadiene-nitrile, polyesters, polyethers, polymer derivatives of methyl methacrylate, polymer derivatives of acrylonitrile, carboxymethylcellulose and derivatives thereof, polyvinyl acetates or polyacrylate acetate, vinylidene fluoride polymers, and mixtures thereof.

The binder or binders may represent from 0.1 to 10 wt %, preferably from 0.2 to 5 wt %, and in particular from 0.5 to 3 wt %, relative to the total weight of the electrode.

Preferably, in one embodiment, the electrode according to the invention comprises at least two binders.

Particularly in this embodiment, the electrode comprises a first binder selected from polyesters, polyethers, polymer derivatives of methyl methacrylate, polymer derivatives of acrylonitrile, carboxymethylcellulose (CMC) and derivatives thereof, polyvinyl acetates or polyacrylate acetate and vinylidene fluoride polymers, and a second binder selected from polybutadiene-styrene latices.

The invention also relates to a lithium-ion cell for storage of electrical energy comprising a negative electrode and a positive electrode, said negative electrode being as defined above.

The positive electrode of the lithium-ion cell according to the invention may be any positive electrode used conventionally in lithium-ion batteries.

The cell generally comprises a separator, which may be selected from all the separators used conventionally by a person skilled in the art.

The electrode is generally impregnated with an electrolyte, preferably liquid.

This electrolyte generally comprises one or more lithium salts and one or more solvents.

The lithium salt or salts may be selected from lithium bis [(trifluoromethyl)sulfonyl]imide (LiN(CF₃SO₂)₂), lithium trifluoromethane sulfonate (LiCF₃SO₃), lithium bis(oxalato)borate (LiBOB), lithium bis(perfluoroethylsulfonyl)imide (LiN(CF₃CF₂SO₂)₂), LiClO₄, LiAsF₆, LiPF₆, LiBF₄, LiI, LiCH₃SO₃, LiB(C₂O₄)₂, LiR_{F}SOSR_{F}, LiN(R_{F}SO₂)₂, LiC(R_{F}SO₂)₃, R_{F} being a group selected from a fluorine atom and a perfluoroalkyl group comprising between one and eight carbon atoms.

The lithium salt or salts are preferably dissolved in one or more solvents selected from polar aprotic solvents, for example ethylene carbonate (designated “EC”), propylene carbonate (PC), dimethyl carbonate (DMC), diethyl carbonate (designated “DEC”) and methyl ethyl carbonate (EMC).

Finally, the invention relates to a lithium-ion battery comprising one or more cells as defined above.

The invention also relates to a method for preparing an electrode as defined above comprising the following steps:
i) mechanically grinding carbon fibers and silicon particles in the presence of a solvent,
ii) drying the mixture obtained in step i) until the solvent has disappeared completely,
iii) adding the dried ground product obtained in step ii) to the particles of graphitic carbon,
iv) mixing the whole in the presence of at least one binder and optionally water,
v) spreading the mixture obtained in step iv) on a current collector,
vi) drying.

Preferably, in the method according to the invention, the grinding in step i) is carried out using a planetary grinding mill with agate balls.

The grinding in step i) is generally carried out at room temperature for a time between 30 min and 2 hours.

The solvent used in step i) is generally cyclohexane or hexane.

In step ii), drying is generally carried out by means of a stove, preferably a ventilated stove.

In general, the drying step ii) is carried out at a temperature between 40° C. and 100° C., preferably about 60° C., and for 24 to 48 hours.

Mixing of the ground product and the particles of graphitic carbon in step iii) is generally carried out at room temperature for a time between 5 minutes and 1 hour.

The mixture obtained at the end of step iv) is an ink.

The ink obtained in step iv) generally has a dry matter content between 40 and 60%.

The ink is then spread on a current collector, and then the electrode is dried.

The current collector may be selected from thin metal sheets comprising metals such as copper, nickel, titanium, aluminum, steel, stainless steel and their alloys, and preferably copper and nickel.

The present invention is illustrated by the following examples but is not limited to these.

### EXAMPLES

### Example 1

### Specific Capacity in Deinsertion

Preparation of the composite materials

A composite material A according to the invention and a comparative composite material B with the same composition are prepared according to the following protocols and in the proportions as given in Table 1 below.

TABLE 1

| Composite materials | |
|---|---|
| A and B | Content (by weight per 100 g) |
| Carbon fibers⁽¹⁾ | 2 |
| Silicon⁽²⁾ | 5 |
| Graphitic carbon⁽³⁾ | 93 |

⁽¹⁾carbon fibers grown in the vapor phase (VGCF)
⁽²⁾average particle size: 300 nm
⁽³⁾TIMREX ® SLP30 sold by the company TIMCAL

1) For Composite Material a

Grinding (Step i)

Mechanical grinding is carried out with a planetary grinding mill with agate balls made by Retsch, comprising 7 g of mixture of carbon fibers and silicon. The quantity of agate balls is 150 g. The mixture thus constituted is ground for 1.5 h at 500 rev/min in a long-chain alkane of the cyclohexane or hexane type; the carbon fibers may have a size between 2 and 20 μm and a diameter less than or equal to 150 nm, and the silicon particles may have a size less than or equal to 4 μm.

Drying (Step ii)

After grinding, the mixture consisting of carbon fibers and silicon is dried for 24 to 48 hours in a ventilated stove equipped with an extractor at a temperature of 55° C.

Mixing (Step iii)

The ground product is then weighed with a precision balance, and then dispersed in a double-jacketed beaker containing 10 g of water using a propeller-type dispersing mixer with a diameter of 30 mm made by Dispermat, at 6000 rev/min for 15 minutes.

The graphitic carbon is then added.

2) For Composite Material B

The grinding step is not used.

The carbon fibers and the silicon are weighed in the same proportions as for preparing composite material A using a precision balance, and then simply dispersed successively in a double-jacketed beaker containing 11 g of water using a propeller-type dispersing mixer with a diameter of 30 mm made by Dispermat, at 6000 rev/min for 15 minutes.

Preparation of the Electrodes

An electrode A according to the invention (composite material A) and a comparative electrode B (composite material B) with the same composition are prepared according to the following protocol and with the ingredients and contents as shown in Table 2.

All the percentages are given by weight.

TABLE 2

| Electrodes A and B | Content (by weight per 100 g) |
|---|---|
| Composite material | 96 |
| Binder 1⁽¹⁾ | 2 |
| Binder 2⁽²⁾ | 2 |

⁽¹⁾carboxymethylcellulose (CMC)
⁽²⁾latex of the styrene-butadiene type in emulsion at 51% in water (BASF LD417)

Preparation of the Inks (Step iv)

Binder 1 (CMC) is added to the composite material.

The composite material (A or B), water and binder 1 are then mixed using a propeller-type dispersing mixer with a diameter of 30 mm made by Dispermat, at 3700 rev/min for 5 minutes.

The mixture obtained is then processed in a grinding mill of the three-roller type made by Exakt and of the PBRO01EXA type at a speed of 300 rev/min.

Binder 2 is then added.

The amount of solvent (water) present in the mixture thus constituted represents from 52 to 54 wt %, relative to the total weight of the mixture.

The inks thus obtained are used for preparing an electrode A according to the invention and a comparative electrode B.

Spreading and Drying (Steps v and vi)

The electrodes are prepared by spreading a film about 90 to 120 μm thick of the inks previously prepared on a copper current collector with a thickness of 10 μm. The electrodes are then dried to give a thickness of 50 to 60 microns.

The electrodes thus prepared are densified in order to obtain a porosity of the composite in the range 30 to 40% by hot calendering.

The electrodes obtained (electrode A according to the invention and comparative electrode B) at the end of this process are analyzed using scanning electron microscopy (SEM).

FIG. 1 shows a scanning electron micrograph of the comparative electrode B.

FIG. 2 shows a scanning electron micrograph of electrode A according to the invention.

The white grains are the chemical signature of silicon.

The photographs show that pretreatment of the carbon fibers and silicon endows the mixture with homogeneity of composition.

In fact, grinding of the carbon fibers with the silicon leads to more homogeneous dispersion of these two compounds in the graphitic carbon matrix.

Preparation of the Cells

Lithium cells of the “button cell” type are prepared by stacking a lithium negative electrode, a positive electrode as prepared above and a polymer separator of the Celgard type, the face of the electrode prepared above being opposite the metallic-lithium negative electrode.

The negative electrodes are formed from a circular film of lithium with diameter of 16 mm and thickness of 100 μm, deposited on a stainless steel disk.

The separator is impregnated with a liquid electrolyte based on LIPF₆ at a concentration of 1 mol/L in a mixture of carbonates.

Testing the Cells

Cell A according to the invention (corresponding to electrode A) and the comparative cell B (corresponding to electrode B) were tested at a temperature of 20° C. according to the following protocol
charging in a regime of 0.1 C in constant-current mode (constant electric current intensity) until a potential of 0.01 V is reached relative to the Li′/Li couple, followed by a phase in constant-voltage mode (constant potential of the electric current) at a potential of 0.01 V until the insertion current is less than or equal to 0.001 C, then
discharge in a regime of 0.1 C in constant-current mode until a potential of 1.2 V is reached relative to the Li⁺/Li couple,
the specific capacity in deinsertion (which corresponds to the capacity contained in the negative electrode during discharge of the Li-ion cell) is measured and then the protocol is started again.

The specific capacity in deinsertion corresponds to the amount of electricity in mA delivered by the electrode tested multiplied by the time from the start of the charging phase to attainment of the charge cut-off potential, divided by the weight of active composite material deposited on the electrode.

The results in terms of electrochemical performance are presented in FIG. 3, which describes the specific capacity in deinsertion of electrodes A and B, as a function of the number of successive charge/discharge cycles.

This s figure shows that the specific capacity in deinsertion drops sharply in the case of electrode B starting from the first cycles of use.

However, electrode A according to the invention maintains a relatively constant specific capacity in deinsertion.

### Example 2

### Retention of Discharge Capacity

Two comparative electrodes C and D and an electrode E according to the invention are prepared with the characteristics for each electrode as indicated in Table 3 below.

TABLE 3

| | Presence of carbon | Grinding of the |
|---|---|---|
| | fibers in the | carbon fibers and |
| Electrode | composite material | silicon |
| C | No | No |
| D | Yes | No |
| E | Yes | Yes |

Preparation of the Composite Materials

The corresponding composite materials (C, D and E) are prepared according to the following protocols and in the proportions as given in Table 4 below.

The contents are given by weight per 100 g.

TABLE 4

| Composite material | C | D | E |
|---|---|---|---|
| Carbon fibers⁽¹⁾ | — | 2 | 2 |
| Silicon⁽²⁾ | 5 | 5 | 5 |
| Graphitic carbon⁽³⁾ | 95 | 93 | 93 |

⁽¹⁾carbon fibers grown in the vapor phase (VGCF)
⁽²⁾average particle size: 300 nm
⁽³⁾TIMREX ® SLP30 sold by the company TIMCAL

1) For Composite Material C

The silicon is simply mixed with the graphitic carbon.

2) For Composite Material D

Preparation of composite material D is identical to preparation of composite material B described above.

3) For Composite Material E

Preparation of composite material E is identical to preparation of composite material A described above.

Preparation of the Electrodes

The three electrodes C, D and E are prepared according to the protocol already described for electrodes A and B and with the ingredients and the contents as shown in Table 5 below.

All the percentages are given by weight.

TABLE 5

| Electrodes C, D and E | Content (by weight per 100 g) |
|---|---|
| Composite material | 96 |
| Binder 1⁽¹⁾ | 2 |
| Binder 2⁽²⁾ | 2 |

⁽¹⁾carboxymethylcellulose (CMC)
⁽²⁾latex of the styrene-butadiene type in emulsion at 51% in water (BASF LD417)

The negative electrodes obtained C, D and E have a surface area of 12.25 cm².

Preparation of the Cells

Lithium-ion cells are prepared by stacking a negative electrode as prepared above (C, D or E), a positive electrode based on LiNi_{1/3}Mn_{1/3}Co_{1/3}O₂ and having a surface area of 10.2 cm² and a polymer separator of the Celgard type, the face of the negative electrode being opposite the positive electrode.

The separator is impregnated with a liquid electrolyte based on LiPF₆ at a concentration of 1 mol/L in a mixture of carbonates.

Testing the Cells

Cell E according to the invention (corresponding to electrode E) and the comparative cells C and D (corresponding to electrodes C and D) were tested at a temperature of 20° C. according to the following protocol
Formation of the cell by charging in a regime of 0.1 C in constant-current mode until a potential of 4.15 V is reached, followed by discharge in constant-current mode to 2.8 V.

This step is carried out three times.

The cyclability of the cell is then tested in order to evaluate the cell's service life.

It consists of: charging in constant-current mode in the regime of 1 C up to 4.15 V, followed by discharge in constant-current mode in the regime of 1 C to 2.8 V, the charge/discharge cycle being repeated as many times as necessary for the investigation.

The results for the three cells C, D and E are presented in the graph in FIG. 4 and in Table 6 below.

FIG. 4 shows retention of the discharge capacity, i.e. the energy capacity still available during discharge of the cell as the charge/discharge cycles proceed.

The retention of the discharge capacity is therefore an indicator of the battery's service life. When this retention becomes too low, the cell becomes unusable.

TABLE 6

| | | Percentage of |
|---|---|---|
| | Initial capacity of the | discharge capacity |
| Cell | cell in mA/h | at cycle 100 |
| C (comparative) | 16.5 | 3% |
| D (comparative) | 28.4 | 42% |
| E (invention) | 25.8 | 68% |

These data show that the initial capacity of the cell is increased considerably when carbon fibers are present in the composite material of the electrode (comparison of cells C and D, and C and E).

However, the discharge capacity at cycle 100 is greatly improved when the carbon fibers and the silicon are ground prior to being distributed in the graphitic carbon (comparison of cells D and E).

1. A composite electrode material based on graphitic carbon comprising a ground product, dispersed within the graphitic carbon, of an intimate mixture of carbon fibers and silicon.

2. The material as claimed in claim 1, wherein the graphitic carbon represents from 80 to 99 wt % relative to the total weight of the composite material.

3. The material as claimed in claim 1, wherein the graphitic carbon is in the form of particles with an average size between 1 and 100 μm.

4. The material as claimed in claim 1, wherein the silicon represents from 0.1 to 15 wt % relative to the total weight of the composite material.

5. The material as claimed in claim 1, wherein the silicon is in the form of particles with an average size less than or equal to 4 μm.

6. The material as claimed in claim 1, wherein the carbon fibers are carbon fibers grown in the vapor phase (VGCF).

7. The material as claimed in claim 1, wherein the carbon fibers represent from 0.1 to 10 wt % relative to the total weight of the composite material.

8. The material as claimed in claim 1, wherein the carbon fibers have an average length between 1 and 40 μm and a diameter less than or equal to 150 nm.

9. The material as claimed in claim 1, wherein the weight ratio of the amount of silicon to the amount of carbon fibers is between 1 and 10.

10. An electrode for electrical energy storage batteries comprising the material as claimed in claim 1, and one or more binders.

11. The electrode as claimed in claim 10, wherein said binder or binders are selected from latices of polybutadiene-styrene, polybutadiene-nitrile and organic polymers, and preferably from latices of polybutadiene-styrene, polybutadiene-nitrile, polyesters, polyethers, polymer derivatives of methyl methacrylate, polymer derivatives of acrylonitrile, carboxymethylcellulose and derivatives thereof, polyvinyl acetates or polyacrylate acetate, vinylidene fluoride polymers, and mixtures thereof.

12. The electrode as claimed in claim 11, wherein the binder or binders represent from 0.1 to 10 wt % relative to the total weight of the electrode.

13. A lithium-ion cell for storage of electrical energy comprising a negative electrode and a positive electrode, said negative electrode being the electrode as claimed in claim 10.

14. An electrical energy storage battery comprising one or more cells as claimed in claim 13.

15. A method for preparing an electrode as claimed in claim 10, comprising:
i) mechanically grinding carbon fibers and silicon particles in the presence of a solvent,
ii) drying the mixture obtained in step i) until the solvent has disappeared completely,
iii) adding the dried ground product obtained in step ii) to the particles of graphitic carbon,
iv) mixing the whole in the presence of at least one binder,
v) spreading the mixture obtained in step iv) on a current collector, and
vi) drying.

16. The method as claimed in claim 15, wherein the grinding in step i) is carried out using a planetary grinding mill with agate balls.
